(19) United States
(12) Patent Application Publication
(10) Pub. No.: US 2013/0262894 A1
(43) Pub. Date: Oct. 3, 2013

(54) SYSTEM-ON-CHIP, ELECTRONIC SYSTEM INCLUDING SAME, AND METHOD CONTROLLING SAME

(71) Applicant: SAMSUNG ELECTRONICS CO., LTD., Suwon-si (KR)

(72) Inventors: JAE CHEOL LEE, Suwon-si (KR); Boo-Jin Kim, Gunpo-si (KR); Jong Hwan Choi, Seoul (KR); Jung Hi Min, Goyang-si (KR)

(73) Assignee: Samsung Electronics Co., Ltd., Suwon-si (KR)

(21) Appl. No.: 13/832,050

(22) Filed: Mar. 15, 2013

(30) Foreign Application Priority Data
Mar. 29, 2012 (KR) 10-2012-0032459

(51) Int. Cl. G06F 1/32

(52) U.S. Cl. CPC G06F 1/324
USPC 713/322; 713/340

(57) ABSTRACT

A system-on-chip (SoC) operates with a memory device and includes a performance monitoring unit (PMU) that measures memory usage for the memory device, and a central processing unit (CPU) configured to implement a dynamic voltage frequency scaling (DVFS) controller that compares the memory usage during a performance monitoring period with a reference value and selects a control scheme accordingly.

### CROSS-REFERENCE TO RELATED APPLICATIONS

This application claims priority under 35 U.S.C. §119(a) from Korean Patent Application No. 10-2012-0032459 filed on Mar. 29, 2012, the subject matter of which is hereby incorporated by reference.

### BACKGROUND

The inventive concept relates to system-on-chip devices (SoC), electronic systems including SoC, and methods of controlling same. More particularly, the inventive concept relates to SoC that efficiently manage power consumption and performance according to a type of operation being executed, as well as electronic systems including same, and methods of controlling same.

Semiconductor devices commonly referred to as microprocessor are well known in the art. The microprocessor is usually integrated on a single chip, and includes a collection of computational, logic, and data storage circuits. These circuits collectively and cooperatively provide the functional capabilities necessary to perform a range of defined operations. The given sequence and nature of such operations, as executed by a microprocessor, may be defined by software and/or firmware. Microprocessors serve as the computational heart of many electronic systems.

The design and fabrication of SoC have been enabled by advances in a number of technical fields. These advances allow a diverse group of functional blocks to be commonly integrated on a chip or a small set of inter-operated chips. Common functional blocks of SoC include; a central processing unit (CPU), memory block(s), interface block(s), digital signal processing block(s), analog signal processing block(s), multimedia block(s), graphics processing blocks(s), data security block(s), etc. Due to continuing advances in enabling technology, many contemporary electronic systems are based on one or more SoC, including a growing number of portable, battery-powered devices.

Power consumption is always an important design consideration for portable devices. That is, as diverse capabilities and functionality converge in contemporary portable devices, power consumption and performance become important tradeoffs.

One approach to the provision of high performance circuitry in a portable device while also maintaining a reasonable power consumption profile is termed dynamic voltage frequency scaling (DVFS).

DVFS is a control scheme that effectively “scales” (i.e., varies) the operating frequency of and/or the control voltage (e.g., a power voltage) applied to a CPU or other computational circuitry. This type of control scheme is typically defined by an algorithm. By appropriately scaling operating frequency and/or control voltage, DVFS is able to intelligently trade-off performance with power consumption. Thus, when the enabling algorithm recognizes operating periods for the portable device during which reduced levels of performance are acceptable, power consumption may be reduced. Likewise, when the algorithm recognizes operating periods for the portable device demanding higher levels of performance, power consumption may be increased accordingly.

### SUMMARY

According to certain embodiments of the inventive concept, there is provided a system-on-chip (SoC) connected with a memory device. The SoC includes a performance monitoring unit (PMU) configured to measure memory usage for the memory device by the first circuit block, a timer configured to set a performance monitoring period for the PMU, and a central processing unit (CPU) configured to implement a dynamic voltage frequency scaling (DVFS) controller that compares the memory usage measured during the performance monitoring period to a reference value, and select a selected control scheme from among a plurality of control schemes according to the comparison of the memory usage and the reference value.

According to certain embodiments of the inventive concept, there is provided a method of method of operating an electronic system including an input device, a system-on-chip (SoC), and a memory device. The method includes; receiving user input via the input device, executing a program in response to the user input, measuring memory usage for the memory device during execution of the program, and selecting a control scheme for the SoC from among a plurality of control schemes according to the memory usage.

### BRIEF DESCRIPTION OF THE DRAWINGS

The above and other features and advantages of the inventive concept will become more apparent upon consideration of certain exemplary embodiments thereof with reference to the attached drawings in which:

FIG. 1 is a block diagram of an electronic system according to embodiments of the inventive concept;

FIG. 2 is a conceptual diagram further illustrating relationships among elements of a system-on-chip (SoC) according to embodiments of the inventive concept;

FIG. 3 is a table showing one approach to the calculation of memory usage according to embodiments of the inventive concept;

FIG. 4 is a flowchart summarizing one method of controlling a SoC according to embodiments of the inventive concept;

FIG. 5 is a functional diagram further illustrating on one example a chronological order of execution for method steps controlling a SoC according to embodiments of the inventive concept;

FIG. 6 is a general block diagram of an electronic system according to one embodiment of the inventive concept;

FIG. 7 is a block diagram of an electronic system according to another embodiment of the inventive concept;

FIG. 8 is a block diagram of an electronic system according to still another embodiment of the inventive concept;

FIG. 9 is a flowchart summarizing in another example a method of operating an electronic system according to embodiments of the inventive concept; and

FIG. 10 is a diagram further illustrating in the context of portable device screen operation certain embodiments of the inventive concept.

### DETAILED DESCRIPTION

Embodiments of the inventive concept now will be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the scope of the invention to those skilled in the art. Throughout the written description and drawings, like reference numbers and labels are used to denote like or similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

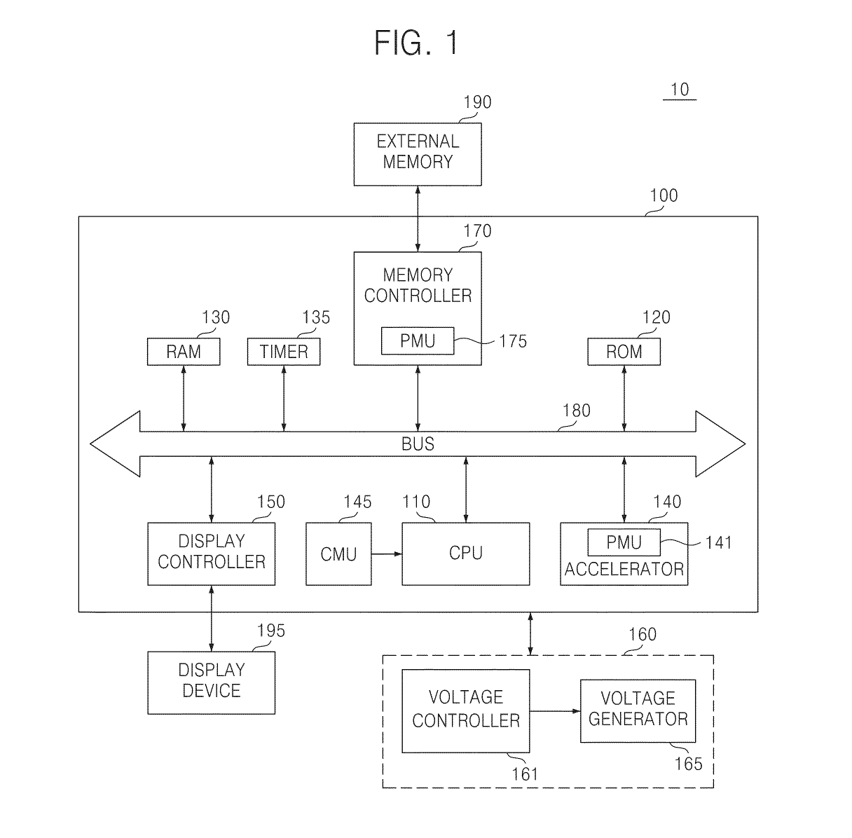

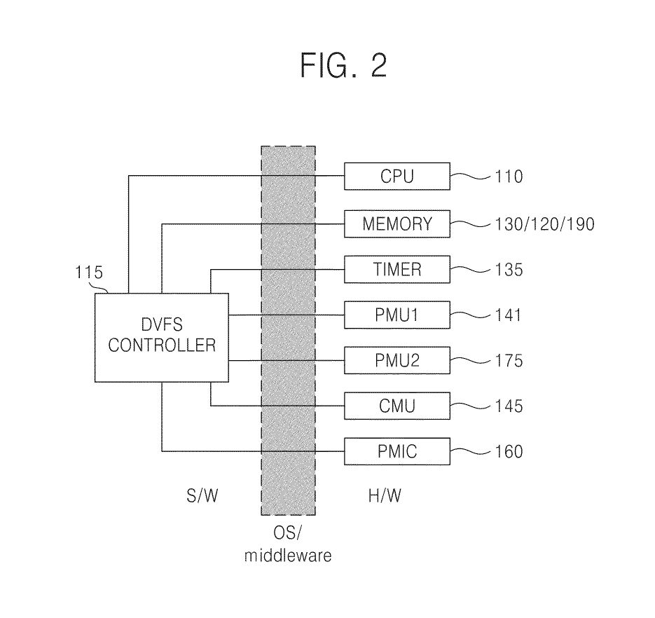

FIG. 1 is a block diagram of an electronic system 10 according to embodiments of the inventive concept. FIG. 2 is a conceptual diagram further illustrating certain relationships between a dynamic voltage frequency scaling (DVFS) controller 115 and elements of the system-on-chip (SoC) of FIG. 1 according to embodiments of the inventive concept.

Referring to FIG. 1, the electronic system 10 may be implemented as a handheld device such as a mobile phone, a smart phone, a tablet computer, a personal digital assistant (PDA), an enterprise digital assistant (EDA), a digital still camera, a digital video camera, a portable multimedia player (PMP), a personal navigation device or portable navigation device (PND), a handheld game console, or an e-book. The electronic system 10 includes the SoC 100, a memory device 190, and a display device 195.

The SoC 100 may include a central processing unit (CPU) 110, read-only memory (ROM) 120, random access memory (RAM) 130, a timer 135, an accelerator 140, a clock management unit (CMU) 145, a display controller 150, a memory controller 170, and a bus 180. The SoC 100 may also include an element, e.g., a television (TV) processor, other than those illustrated in FIG. 1. The electronic system 10 may optionally include a power management integrated circuit (PMIC) 160.

Although the PMIC 160 is implemented external to the SoC 100 in the illustrated embodiment of FIG. 1, it may alternately be implemented internal to the SoC 100 in other embodiments. The PMIC 160 may include a voltage controller 161 and a voltage generator 165.

The CPU 110, which may be referred to as a processor, may be used to process or execute programs and/or data stored in the memory device 190. For instance, the CPU 110 may process or execute the programs and/or data in response to a clock signal output from a clock signal generator (not shown).

The CPU 110 may be implemented by a multi-core processor. The multi-core processor is a single computing component with two or more independent actual processors (referred to as cores). Each of the processors may read and execute program instructions. The multi-core processor can drive a plurality of accelerators at a time, and therefore, a data processing system including the multi-core processor may perform multi-acceleration.

The programs and/or the data stored in the ROM 120, the RAM 130, and the memory device 190 may be loaded to a memory in the CPU 110 when necessary.

The ROM 120 may store permanent programs and/or data. The ROM 120 may be implemented by erasable programmable ROM (EPROM) or electrically erasable programmable ROM (EEPROM).

The RAM 130 may temporarily store programs, data, or instructions. The programs and/or data stored in the memory 120 or 190 may be temporarily stored in the RAM 130 according to the control of the CPU 110 or a booting code stored in the ROM 120. The RAM 130 may be implemented by dynamic RAM (DRAM) or static RAM (SRAM).

The accelerator 140 may refer to a hardware device or a co-processor for increasing the performance of processing multimedia or multimedia data such as text, audio, still images, animation, video, two-dimensional data, or three-dimensional data.

For clarity of the description, only one accelerator 140 is illustrated in FIG. 1, but the SoC 100 may include a plurality of accelerators in other embodiments. At least one application program may drive a single accelerator.

In the illustrated embodiment of FIG. 1, the memory controller 170 includes a performance monitoring unit (PMU) 175. However, the performance monitoring unit 175 may be otherwise provided. Another PMU 141 is provided in conjunction with (i.e., integral to or as a front-end element) the accelerator 140.

Each PMU 141 and 175 is a circuit block and/or software module that may be used to measure the respective memory usage for the memory device 190 by a first block, and provide corresponding “performance information”. The first block may be the memory controller 170, the accelerator 140, or one of other elements included in the SoC 100 that access the memory device 190. For example, the first PMU 141 may measure an amount of input data provided from the memory device 190 to the accelerator 140, an amount output data provided from the accelerator 140 to the memory device 190, and/or a number of access operations directed to the memory device 190 demanded by the accelerator 140 and generate corresponding performance information. In similar vein, the second PMU 175 may measure an amount of input data provided from the memory device 190 to the memory controller 170, an amount output data provided from the memory controller 170 to the memory device 190, and/or a number of access operations directed to the memory device 190 demanded by the memory controller 170 and generate corresponding performance information.

The CMU 145 may be used to generate one or more operating clock signal(s) applied to the CPU 110 and/or other circuits, such as the memory controller 170. In certain embodiments, the CMU 145 may include a phase locked loop (PLL), a delayed locked loop (DLL), or a crystal oscillator. The CMU 145 may be used to vary the frequency of an operating clock signal in response to control information provided by a DVFS controller. (See, DVFS controller 115 of FIG. 2).

In certain embodiments of the inventive concept, the DVFS controller 115 may be used to select a “selected control scheme” from among a plurality of predetermined control schemes in response to performance information (e.g., memory usage information) provide by at least one of the first PMU 141 and the second PMU 175. In this manner, the DVFS controller 115 may be used to control the CMU 145 according to the selected control scheme. In this context, those skilled in the art will recognize that a control scheme may be implemented in software and/or firmware and will include controls functions sufficient to implement a predetermined set of performance conditions (e.g., control voltages, clock frequencies, timing parameters, etc.).

Thus, the CMU 145 may change the frequency of an operating clock signal under the control of the selected control scheme as selected in response to the performance information provided by the DVFS controller 115. Using a simple example to further illustrate this point, a first control scheme may emphasize the data processing speed by increasing the operating frequency of an operating clock signal and/or increasing the level of a control voltage applied to certain circuits in the SoC 100, such as the CPU 110. In contrast, a second control scheme may emphasize power preservation by decreasing the frequency of the operating clock signal and/or reducing the level of a control voltage applied to certain circuits in the SoC 100, such as the CPU 110.

The selection of a control scheme may be influenced by a number of factors. For example, the operation of, or the type of operation by an auxiliary device (not shown) associated with the electronic system 10 may determine the nature of the performance information used to select of a particular control scheme. Regardless of determining factors, control scheme selection within certain embodiments of the inventive concept may be very dynamic in nature. Thus, rapidly changing factors may result in corresponding changes in control scheme to optimize (e.g.,) a trade-off between performance and power consumption.

Where the power management integrated circuit (PMIC) 160 is provided, the voltage controller 161 may be used to control the voltage generator 165 in response to a selected control scheme indicated by the DVFS controller 115. The voltage generator 165 may be used to generate and provide at least one control voltage to circuits in the SoC 100 in accordance with the selected control scheme.

The memory controller 170 is essentially an interface between the external memory device 190 and the SoC 100, and may be used to control the overall operation of the memory device 190, as well as data exchanges between a “host” and the memory device 190. For example, the memory controller 170 may control operation of the memory device 190 during read and write operations resulting from data requests made by the host. From the standpoint of the external memory device 190, the host may be, at any moment in time, any one of a number of “master devices”, including (e.g.,) the CPU 110, the accelerator 140, the display controller 150, etc.

The memory device 190 serves as data storage medium capable of receiving, storing, and providing indicated data under the control of a conventionally understood operating system (OS) and/or similar middleware. In certain embodiments of the inventive concept, the memory device 190 may be implemented using volatile memory such as Dynamic Random Access Memory (DRAM). In other embodiments of the inventive concept, the memory device 190 may be implemented using non-volatile memory such as flash memory, phase-change RAM (PRAM), magneto-resistive RAM (MRAM), resistive RAM (ReRAM) or ferroelectric RAM (FeRAM).

Still other embodiments of the inventive concept may embed the memory device 190 within the SoC 100, rather than providing it externally.

In the illustrated example of FIGS. 1 and 2, the described elements 110, 120, 130, 140, 150, and 170 will communicate with one another via one or more bus(es) 180, as will be understood by those skilled in the art.

The display device 195 may be used to display images defined by multimedia data provide by operation of the accelerator 140, or a software accelerator loaded to the CPU 110. The display device 195 may be a light emitting diode (LED) display device, an organic LED (OLED) display device, or one of other types of display devices. The display controller 150 may be used to control the operations of the display device 195.

As noted above, the memory controller 170 may include a second PMU 175. The second PMU 175 may be used to provide performance information more closely related to the overall operation of the SoC 100. Thus, amounts of input data and/or output data, or memory usage demands between the SoC 100 and external memory 190 may be monitored by the second PMU 175. In contrast, the first PMU 141 associated with the accelerator 140 will provide performance information more locally related to operation of the accelerator 140. Further, the first PMU 175, being disposed in relation to the memory controller 170, may also be used to detect the operation of, or interrupt the operative nature of an auxiliary device external to the SoC 100, but nonetheless influencing the selection of a control scheme.

Thus, in certain embodiments of the inventive concept, performance information (e.g., memory usage information) determined by the first PMU 175 may be applied to the DVFS controller 115. Then, the DVFS controller 115 may be used to select a control scheme that controls the operation of the PMIC 160 and/or the CMU 145. In the illustrated embodiment of FIG. 1, only the first PMU 141 and second PMU 175 are shown. However, additional PMU(s) may be provided in relation to elements 110, 140, 150, and 170 and similar elements of the SoC 100 that access data stored by the memory device 190. When a plurality of PMUs provide corresponding performance information, the DVFS controller 115 may select a control scheme on the basis of single (high priority) performance information, or on the collective basis of more than one performance information. In other words, the DVFS controller 115 may select a control scheme based on a collection of performance information provide by a plurality of PMUs, or may select a control scheme based on a hierarchy of performance information.

It should be noted that a PMU associated with (e.g., disposed at the data front end of) any one of the elements 110, 140, 150, and 170 of the SoC 100, or a similar element accessing data from the memory device 190, may provide performance information that will be considered by the DVFS controller 115. For example, memory usage may form the basis of performance information and may be variously determined. In certain embodiments of the inventive concept, memory usage may be determined by counting a number of “data access events” (e.g., read and/or write operations) occurring between an SoC element 110, 140, 150, 170, etc., and the memory device 190 during a defined period of time.

Referring to FIGS. 1 and 2, the DVFS controller 115 may be implemented in software (S/W) or firmware. The DVFS controller 115 may be implemented as a program and installed in the memory 130, 120 and/or 190. The implementing program may be executed by the CPU 110 when the SoC 100 is powered on.

As illustrated in FIG. 2, the DVFS controller 115 may be used to select one or more control schemes for one or more of the memories 130, 120, and 190, first PMU 141, second PMU 175, CMU 145, and PMIC 160. The memories 130, 120, and 190, timer 135, first PMU 141, second PMU 175, CMU 145, and PMIC 160 may each be implemented in hardware (H/W).

As will be appreciated by those skilled in the art, an operating system (OS) and/or associated middleware may be used to effect control of the DVFS controller 115 over these SoC elements, i.e., memories 130, 120, and 190, timer 135, first PMU 141, second PMU 175, CMU 145, and PMIC 160.

In certain embodiments of the inventive concept, the DVFS controller 115 may use the timer 135 to “set” an operating time, namely a performance monitoring period for each one of the first PMU 141 and second PMU 175. That is, the DVFS controller 115 may set start point(s) and stop point(s) that establish operating period(s) for each PMU. For instance, the DVFS controller 115 may be used to set start point(s) from which each of the PMUs will start determining memory usage, and stop point(s) at which each one of the PMUs will stop determining memory usage.

The DVFS controller 115 may initialize the PMUs before the determination of memory usage. Following initialization of the PMUs, the DVFS controller 115 may establish operating periods for the PMUs and set appropriate start and stop points. In certain embodiments of the inventive concept, the DVFS controller 115 may reset a counter (not shown) used to count data access events during an established operating period. The counter may be implemented in hardware or software, and may be integral to or external to the DVFS controller 115.

Once a PMU has determined performance information (e.g., a counted number of data access operations during a defined time period), said performance information may be stored in a buffer, register, or a memory associated with (e.g.,) the CPU 110, the memory device 190, and/or the PMUs.

In certain embodiments of the inventive concept, the DVFS controller 115 may “weight” performance information before storing it. Weighting factor(s) may be assigned as a function of the length of the time period over which the performance information was determined, or the age of the performance information. Thus, the DVFS controller 115 may assign a lowest weighting factor to oldest performance information and a highest weighting factor to newest performance information. In this manner, a control scheme may be selected by the DVFS controller 115 on the basis of most time-relevant performance information.

In one specific example, the DVFS controller 115 may calculate a weighted mean for performance information using respectively assigned weighting factors. The DVFS controller 115 may then compare the calculated weighted mean with a predetermined reference value in order to select a control scheme. For example, assuming only two (2) available controls schemes—a first scheme emphasizing performance and a second scheme emphasizing power conservation—a determination by the CPU 110 that the weighted mean is less than the reference value will result in selection of the first control scheme while a determination by the CPU 110 that the weighted mean is greater than or equal to the reference value will result in selection of the second control scheme.

Extending this example, when the weighted mean is determined to be greater than or equal to the reference value, the DVFS controller 115 may recognize a heavily involved input/output (I/O) operation requiring relatively many data access operations directed to the memory device 190, and accordingly select the second control scheme that decreases a control voltage and/or an operating clock frequency. However, when the weighted mean is determined to be less than the reference value, the DVFS controller 115 may recognize a computational operation (e.g., a CPU bound operation) requiring few if any data access operations directed to the external memory 190, and accordingly select the first control scheme that increases a control voltage and/or operating clock frequency.

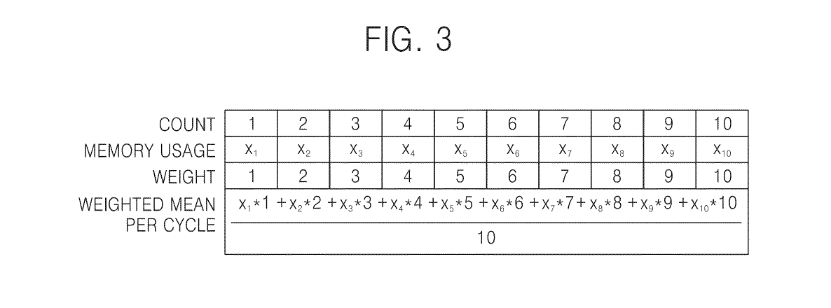

FIG. 3 is a table showing one procedure whereby a PMU may be used to calculate performance information in the form of memory usage according to certain embodiments of the inventive concept. Referring to FIGS. 1, 2 and 3, it is assumed that the second PMU 175 counts the number of data access operations—as being indicative of memory usage—during each one of a number of count (COUNT) periods (1 through 10). Thus, the DVFS controller 115 may be used to set start/stop points for a number of count periods for the second PMU 175.

In response, the second PMU 175 counts data access operations 10 times during the predetermined count periods. Data access operations may variously include (e.g.,) read and/or write operations directed to a particular memory, image display operations, etc. Each count values (x₁ through x₁₀) for data access operations (MEMORY USAGE) is then assigned a corresponding weighting factor (WEIGHT) in its chronological order. The DVFS controller 115 then multiplies each count value (x₁ through x₁₀) with its corresponding weighting factor (WEIGHT) to compensate for differences in the respective measurement (counting) period.

Finally, the DVFS controller 115 may be used to calculate a weighted average for “memory usage” over the range of count periods. In other words, the DVFS controller 115 may perform a weighted average operation on count values for defined data access operations (i.e., memory usages) counted over a number of counting periods.

In the example of FIG. 3 memory usage is “measured” (or approximated) over 10 counting periods ranging from a most recent counting period (x₁₀) to a most distant counting period (x₁). The count value obtained during the most temporally distant period (x₁) receives the lowest weighting (i.e., a weighting factor of ‘1’), while the count value obtained during the most recent period (x₁₀) receives the highest weighting (i.e., a weighing factor of ‘10’) and count values obtained during intervening periods receive corresponding weighing. As a result, a weighted mean may be calculated by the DVFS controller 115 according to the formula [(x₁+2x₂+3x₃+4x₄+5x₅+6x₆+7x₇+8x₈+9x₉+10x₁₀)÷10].

Those skilled in the art will understand that the foregoing example is just one of many different ways in which a weighted value may be derived to appropriately indicate memory usage. Further, where multiple PMUs are incorporated in a SoC, one or more different computational approaches may be used to measure (or approximate) memory usage. In this manner, a particular control scheme may be selected from among a set of available control schemes in accordance with measurement(s) made over one or more predetermined periods.

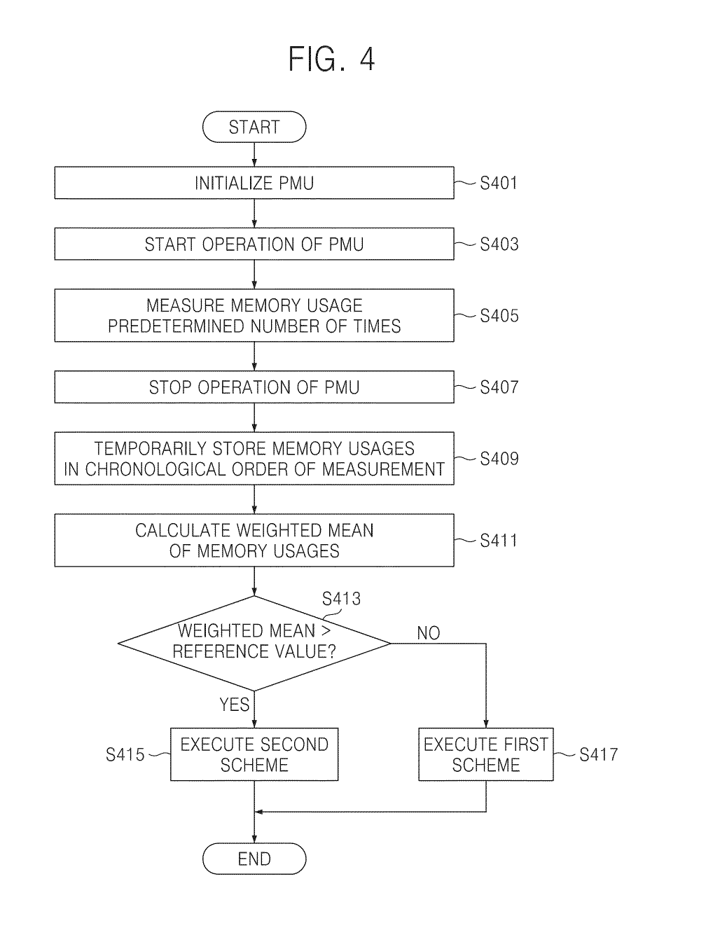

FIG. 4 is a flowchart summarizing a control method for the SoC 100 according to certain embodiments of the inventive concept. Referring collectively to FIGS. 1, 2, and 4, the DVFS controller 115 is assumed to initialize (e.g.,) the first PMU 141 (S401), and then control operation of same over a defined period of time (S403).

The first PMU 141 then measures memory usage according to a given approach, such as the one described above (S405). Following the defined period of time, the DVFS controller 115 stops operation of the first PMU 141 (S407).

The DVFS controller 115 then stores data (e.g., count values) indicating memory usage in a (e.g.,) a designated history buffer of the memory device 190 (S409). If the measurement approach described above is used, count values may be stored in chronological order. The DVFS controller 115 may then be used to multiply the count values indicating memory usage and stored in the history buffer by appropriate, respective weighting factors and then to calculate a weighted mean indicating memory usage over the period of time (S411).

The DVFS controller 115 may next be used to compare the calculated weighted mean with a reference value (S413). When the weighted mean is greater than the reference value, the DVFS controller 115 will control the CMU 145 and/or the PMIC 160 according to the second control scheme (S415). However, when the weighted mean is less or equal to the reference value, the DVFS controller 115 will control the CMU 145 and/or the PMIC 160 according to the first scheme (S417).

According to this type of approach, an electronic system including a SoC according to certain embodiments of the inventive concept may select and uses a control scheme appropriate for the operational load placed upon one or more memories during a given period of time. Operating frequency and/or control voltage scaling may be performed in accordance with the selected control scheme, thereby optimizing trade-offs between performance and power consumption, for example.

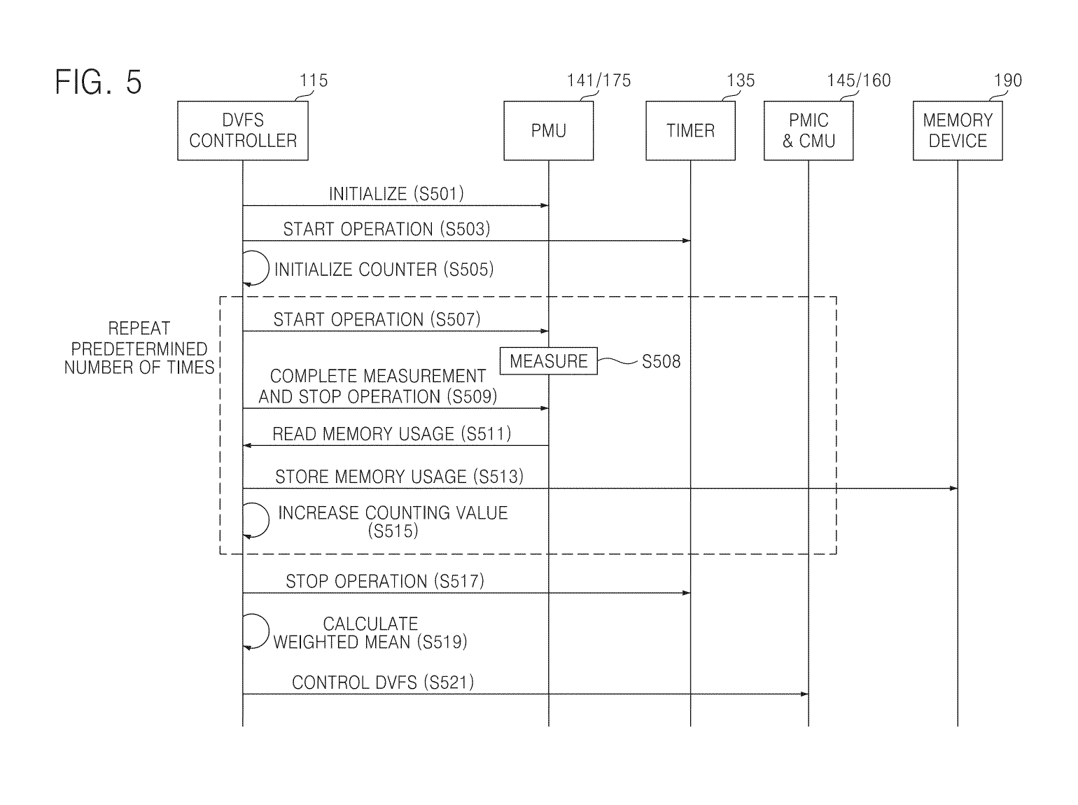

FIG. 5 is a functional diagram further describing a control scheme selection method for the SoC 100 according to certain embodiments of the inventive concept. Referring to FIGS. 1, 2, and 5, in order to measure a memory usage for a predetermined period, the DVFS controller 115 initializes at least one of the first and second PMUs 141 and 175 (S501). It is assumed here that the first PMU 141 is operative. Therefore, the first PMU 141 will measure memory usage during a given period, where memory usage will then be used to select a control scheme.

After initializing the first PMU 141, the DVFS controller 115 starts a timer 135 (S503). The DVFS controller 115 may be used to reset a counter to measure memory usage a predetermined number of times. The DVFS controller 115 initializes the counting operation (S505) during the measurement of memory usage by the first PMU 141.

Thereafter, the DVFS controller 115 starts the first PMU 141 (S507). The first PMU 141 measures memory usage based on a number of access operations executed in relation to the memory device 190 after the measurement start point. After the memory usage is measured, the DVFS controller 115 stops the operation of the first PMU 141 (S509), reads the data (count values) indicating memory usage (S511), and stores the data in the memory device 190 (S513).

After temporarily storing the data indicating memory usage in the memory device 190 obtained during the measurement period, the DVFS controller 115 increments the number of a current counting period (S515) and restarts the first PMU 141 to again measure memory usage for the predetermined period and temporarily stores the memory usage in the memory device 190.

When the number of the current counting period reaches a defined maximum, the DVFS controller 115 stops the first PMU 141 at an end point of the measurement cycle which may be set by a time setting module, i.e., the timer 135, (S517).

The DVFS controller 115 then assigns a weighting factor to each data corresponding to a counting period, and calculates a weighted mean of the data to obtain a single value appropriately indicating memory usage over the entire given period of time (S519).

The DVFS controller 115 then compares the weighted mean with a predetermined reference value and selects either the first control scheme emphasizing performance or the second control scheme emphasizing power conservation (S521). Under the control of the first control scheme, the DVFS controller 115 may increase the operating frequency and the operating voltage of the SoC 100 through the CMU 145 and/or PMIC 160. Under the control of the second control scheme, the DVFS controller 115 may decrease the operating frequency and the operating voltage of the SoC 100 through the CMU 145 and/or PMIC 160.

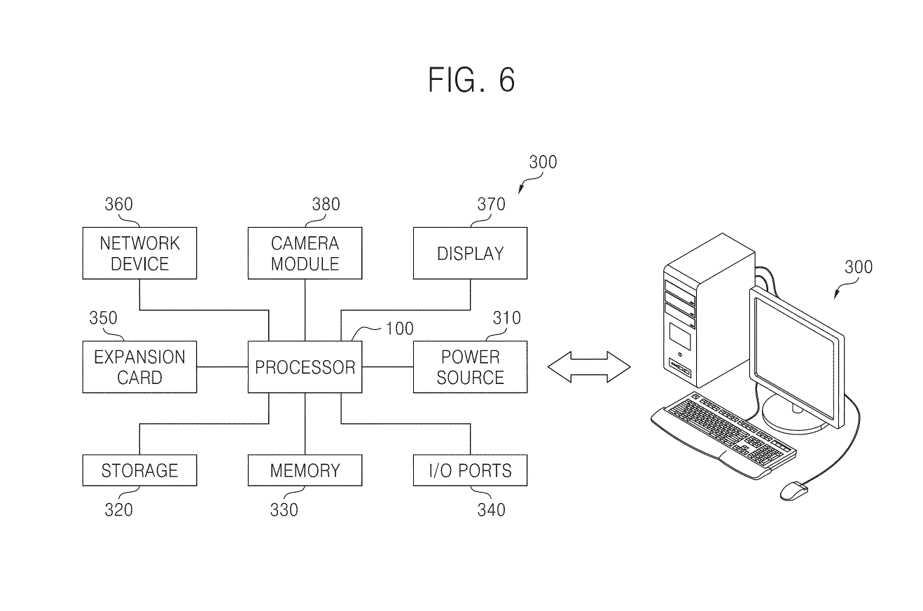

FIG. 6 is a block diagram of an electronic system 200 according to an embodiment of the inventive concept. Referring to FIG. 6, the electronic system 200 may be implemented as a personal computer (PC) or a data server.

The electronic system 200 includes the processor 100, a power source 210, a storage 220, a memory 230, I/O ports 240, an expansion card 250, a network device 260, and a display 270. The electronic system 200 may also include a camera module 280.

The processor 100 is the SoC 100 illustrated in FIG. 1. The processor 100 may be a multi-core processor. The processor 100 may control the operation of at least one of the elements 210 through 280.

The power source 210 may supply an operating voltage to at least one of the elements 100 and 220 through 280. The storage 220 may be implemented by a hard disk drive (HDD) or a solid state drive (SSD).

The memory 230 may be implemented by a volatile or non-volatile memory and may correspond to the memory device 190 illustrated in FIG. 1. A memory controller (not shown) that controls a data access operation, e.g., a read operation, a write operation (or a program operation), or an erase operation, on the memory 230 may be integrated into or embedded in the processor 100. Alternatively, the memory controller may be provided between the processor 100 and the memory 230.

The I/O ports 240 are ports that receive data transmitted to the electronic system 200 or transmit data from the electronic system 200 to an external device. For instance, the I/O ports 240 may include a port connecting with a pointing device such as a computer mouse, a port connecting with a printer, and a port connecting with a USB drive.

The expansion card 250 may be implemented as a secure digital (SD) card or a multimedia card (MMC). The expansion card 250 may be a subscriber identity module (SIM) card or a universal SIM (USIM) card.

The network device 260 enables the electronic system 200 to be connected with a wired or wireless network. The display 270 displays data output from the storage 220, the memory 230, the I/O ports 240, the expansion card 250, or the network device 260.

The camera module 280 is a module that converts an optical image into an electrical image. The electrical image output from the camera module 280 may be stored in the storage 220, the memory 230, or the expansion card 250. The electrical image output from the camera module 280 may also be displayed on the display 270.

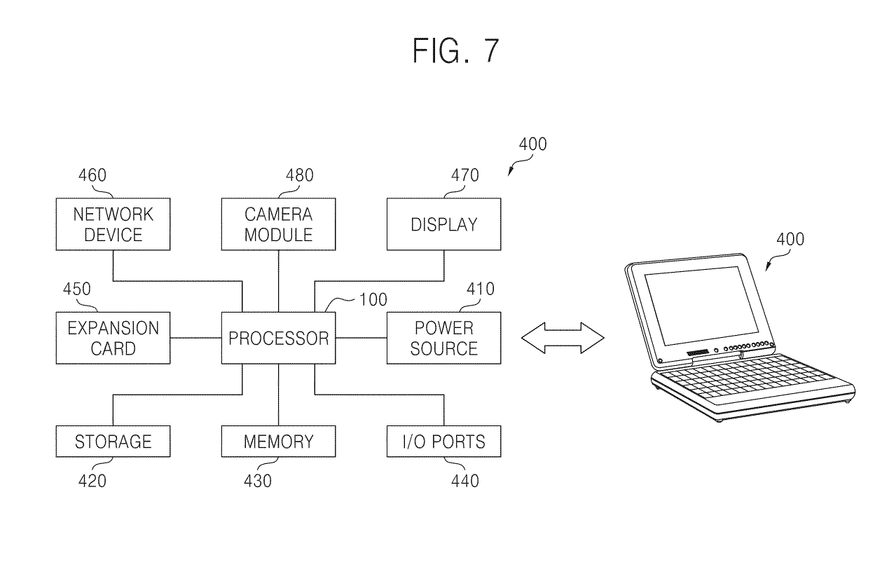

FIG. 7 is a block diagram of an electronic system 300 according to another embodiment of the inventive concept. Referring to FIG. 7, the electronic system 300 may be implemented as a laptop computer.

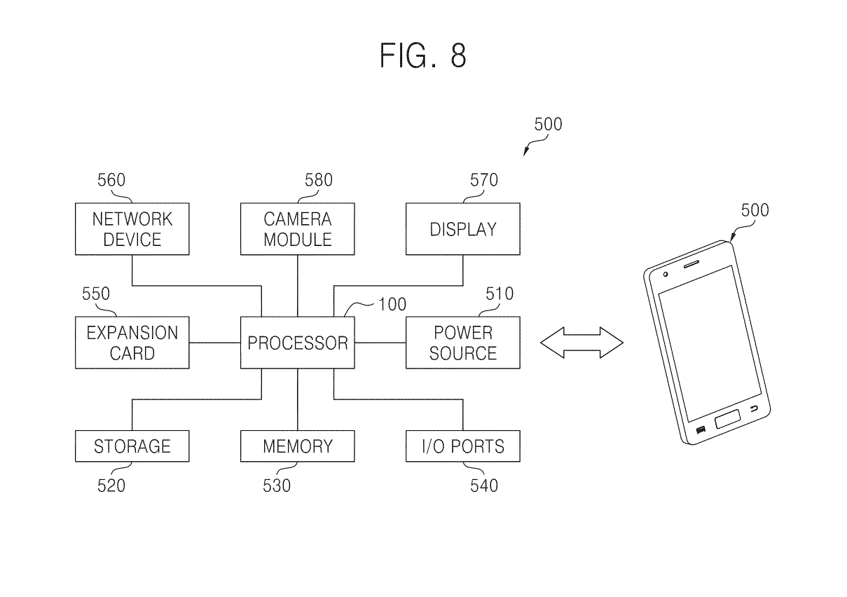

FIG. 8 is a block diagram of an electronic system 400 according to still another embodiment of the inventive concept. Referring to FIG. 8, the electronic system 400 may be implemented as a portable device. The portable device may be a mobile phone, a smart phone, a tablet PC, a personal digital assistant (PDA), an enterprise digital assistant (EDA), a digital still camera, a digital video camera, a portable multimedia player (PMP), a personal navigation device or portable navigation device (PND), a handheld game console, or an e-book.

In FIGS. 7 and 8, analogous reference numbers with FIG. 6 indicate analogous features.

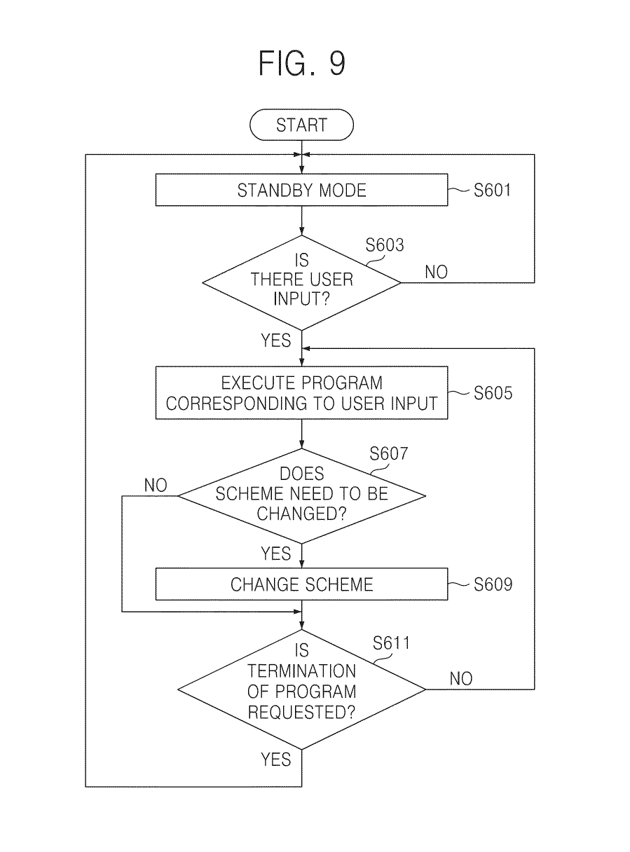

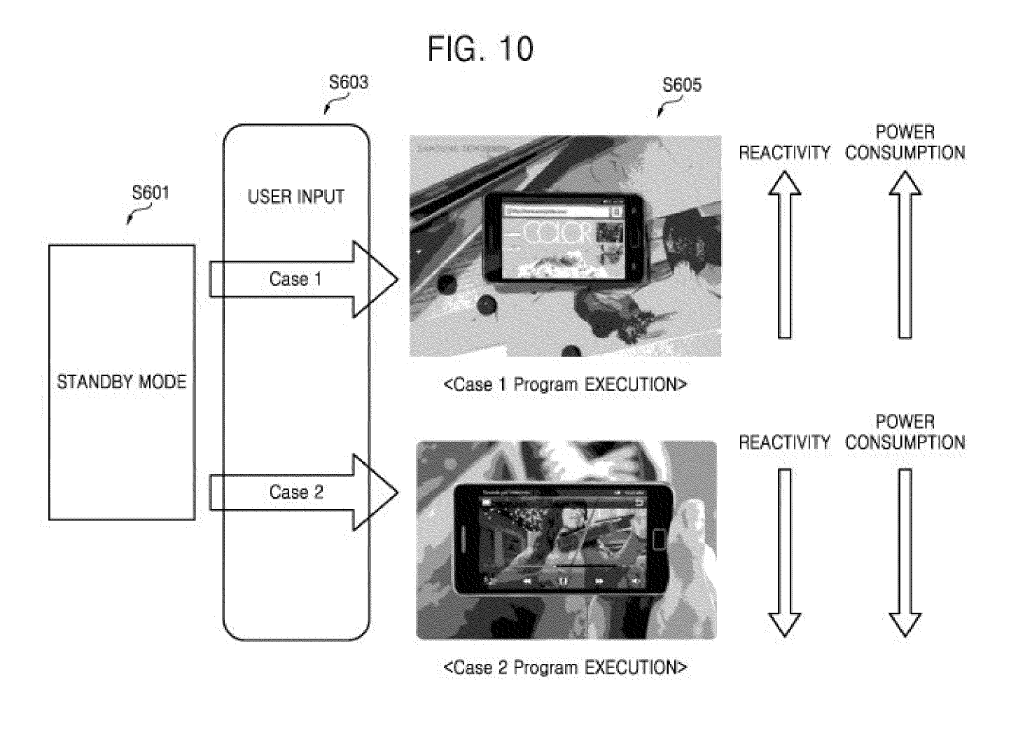

FIG. 9 is a flowchart summarizing a control method for an electronic system according to certain embodiments of the inventive concept. FIG. 10 is a conceptual diagram further illustrating screen operations for an electronic system consistent with the control method of FIG. 10. The method illustrated in FIGS. 9 and 10 may be applied, for example, to the electronic device 400 of FIG. 8.

Referring to FIGS. 8, 9 and 10, the electronic system 400 is initially assumed to be standby mode (S601). Although not shown in FIG. 10, a DVFS controller like the ones previously described may operate to control one or more PMU, measure memory usage, and select a control scheme based on the measured memory usage while in the standby mode. When user input is received while the electronic system 400 is in the standby mode (S603), a program indicated by the user input may be executed (S605). Here, an input device applying a control signal (or data) to the operation of the electronic system 400 may be (e.g.,) a pointing device such as a touch pad, a computer mouse, a keypad, or a keyboard.

While the program indicated by the user input is being executed, a PMU may measure memory usage under the control of the DVFS controller 115. The DVFS controller 115 may then determine whether a current control scheme should be changed based on the measured memory usage (S607). When it is determined that the current control scheme should be changed, another control scheme other than the current control scheme may be selected from among a set of available control schemes (S609). When it is determined that the current control scheme does not need to be changed, the current control scheme is retained. When termination of the program (S611=YES), the program is terminated and the electronic system 400 returns to the standby mode (S601). However, where there is no request for termination of the program (S611=NO), the program continues execution.

Referring to FIG. 10, a web browsing program may be executed in response to a user input in case 1. When the web browsing program is executed, a memory usage may be low. In this case, a first scheme focusing on processing performance by increasing the operating frequency and the operating voltage of the processor 100 may be selected. Accordingly, reactivity and power consumption may increase. However, in case 2 where a video player is executed in response to a user input, a memory usage may be high. In this case, a second scheme focusing on reducing power consumption by decreasing the operating frequency and the operating voltage of the processor 100 may be selected. Accordingly, the reactivity and the power consumption may decrease.

In the above description, certain embodiments of the inventive concept have been presented that select among a plurality of control schemes based on memory usage. However, the inventive concept is not restricted thereto. For instance, a thermal monitoring unit (TMU) may be provided in the accelerator 140 of the SoC 100 illustrated in FIG. 1 and one of the schemes may be selected based on a temperature measured by the TMU. That is, when temperature measured by the TMU is less than a predetermined reference value, a first control scheme emphasizing processing performance by increasing the operating frequency and the operating voltage may be selected. In contrast, when the temperature measured by the TMU is greater than the predetermined reference value, a second control scheme emphasizing power conservation by decreasing the operating frequency and the operating voltage may be selected. The TMU may be included in another element (e.g., the CPU 110) of the SoC 100 as well as the accelerator 140.

As described above, according to certain embodiments of the inventive concept, instead of using one fixed DVFS scheme, a plurality of DVFS schemes are used to adjust the operating frequency and the operating voltage of an electronic system when necessary, thereby increasing overall performance and reducing power consumption. In addition, the operating frequency and the operating voltage of the system are adjusted using memory usage measured over predetermined intervals, thereby dynamically adjusting the operating frequency and the operating voltage.

While the inventive concept has been particularly shown and described with reference to exemplary embodiments thereof, it will be understood by those of ordinary skill in the art that various changes in forms and details may be made therein without departing from the scope of the inventive concept as defined by the following claims.

What is claimed is:

1. A system-on-chip (SoC) including a first circuit block, the SoC being operatively connected with a memory device, the SoC comprising:
a performance monitoring unit (PMU) configured to measure memory usage for the memory device by the first circuit block;
a timer configured to set a performance monitoring period for the PMU; and
a central processing unit (CPU) configured to implement a dynamic voltage frequency scaling (DVFS) controller that compares the memory usage measured during the performance monitoring period to a reference value, and select a selected control scheme from among a plurality of control schemes according to the comparison of the memory usage and the reference value.

2. The SoC of claim 1, further comprising at least one of a clock management unit configured to adjust an operating frequency of the SoC according to the selected control scheme, and a power management integrated circuit configured to adjust an operating voltage of the SoC according to the selected control scheme.

3. The SoC of claim 2, wherein the plurality of control schemes comprises a first control scheme increasing at least one of the operating frequency and the operating voltage of the SoC, and a second scheme decreasing at least one of the operating frequency and the operating voltage of the SoC.

4. The SoC of claim 1, wherein memory usage is determined according to least one of an amount of data communicated from SoC to the memory device, an amount of data communicated from the memory device to the SoC, and a number of access operations directed to the memory device.

5. The SoC of claim 3, wherein the DVFS controller is configured to initialize the PMU and control operation of the PMU during the performance monitoring period.

6. The SoC of claim 5, wherein the DVFS controller is further configured to define a number of periods during the performance monitoring period, determine data indicating memory usage during each one of the number of periods, and store the data in the memory device.

7. The SoC of claim 6, wherein the DVFS controller is further configured to calculate a weighted mean using the data stored in the memory device, wherein the weighted mean indicates memory usage over the performance monitoring period.

8. The SoC of claim 7, wherein the DVFS controller is further configured to compare the weighted mean to the reference value, and select the first control scheme when the weighted mean is less than the reference value, else select the second control scheme when the weighted mean is greater than or equal to the reference value.

9. The SoC of claim 8, wherein calculation of the weighted mean by the DVFS controller comprises respectively multiplying the data for each one of the number of periods by a weighting factor.

10. The SoC of claim 9, wherein data associated with more recent ones of the number of periods are more heavily weighted than data associated with less recent ones of the number of periods.

11. The SoC of claim 1, wherein the first circuit block is a memory controller.

12. The SoC of claim 1, the first circuit block is an accelerator for increasing performance of processing multimedia data.

13. A method of managing power consumption and performance of a system on chip (SoC), the method comprising:
executing a program;
measuring memory usage for a memory device during execution of the program;
repeating the executing the program and the measuring the memory usage for a predetermined number of times;
calculating a weighted mean based on data indicating the memory usage
comparing the weighted mean with a reference value; and
selecting a control scheme for the SoC from among a plurality of control schemes according to a comparing result.

14. The method of claim 13, further comprising:
adjusting at least one of an operating frequency and an operating voltage of the SoC according to the selected control scheme.

15. The method of claim 14, further comprising:
storing the data indicating memory usage over a number of periods in a performance monitoring period.

16. The method of claim 15, further comprising:
executing a first control scheme when the weighted mean is less than the reference value, else executing a second control scheme when the weighted mean is greater than or equal to the reference value.

17. The method of claim 13, wherein memory usage is determined according to least one of an amount of data communicated from SoC to the memory device, an amount of data communicated from the memory device to the SoC, and a number of access operations directed to the memory device.

18. The method of claim 13, wherein the measuring of memory usage for the memory device during execution of the program is performed by a performance monitoring unit configured with a memory controller that controls an exchange of data between the SoC and the memory device.

19. The method of claim 13, wherein the measuring of memory usage for the memory device during execution of the program is performed by a performance monitoring unit configured with an accelerator for increasing performance of processing multimedia data.
